(19) United States
(12) Patent Application Publication
(10) Pub. No.: US 2012/0185444 A1
(43) Pub. Date: Jul. 19, 2012

(54) Clock Monitoring in a Data-Retention Storage System

(76) Inventors: Andrew SPARKES, Bristol (GB); Michael J. SPITZER, Portland, OR (US)

(21) Appl. No.: 13/006,790

(22) Filed: Jan. 14, 2011

(51) Int. Cl. G06F 17/30

(52) U.S. Cl. 707/689; 707/E17.007

(57) ABSTRACT

A clustered storage system includes a machine arranged to check, using its own clock as a current time reference, for expiry of a retention period set for a dataset stored in the system. In order to monitor for any interference with its clock, the expiry-checking machine obtains from other machines of the system, the current times of their clocks, and then derives a value from these times which it compares with a current time value from its own clock; where the difference between these values exceeds a predetermined amount, the expiry-checking machine generates an alert. This monitoring process is carried out repeatedly.

### BACKGROUND

Many regulatory authorities and enterprise internal policies require the retention of certain data for a specified period (the “retention period”). As the data required to be retained in this manner is generally intended to provide a reliable record of contemporaneous events (such as stock exchange transactions), the data held in retention is required to be protected against change, at least to some degree.

Much of the data subject to a data retention regime will be in electronic form. Write-once-read-many, WORM, storage systems are well suited for retaining electronic data in immutable form. In a WORM storage system, data to be retained is stored in WORM files and the system provides protection mechanisms preventing changes to the file and at least some of its metadata. Generally, a WORM storage system is not limited to the storage of WORM files and may store non-WORM files as well; as a consequence, the protection provided to WORM files includes protection of the designation of a file as a WORM file, whatever form this designation may take.

In the context of data retention, the “write once” in relation to a WORM file refers to the form of the file data at the point the file is designated a WORM file (it being understood that the file may have undergone many re-writes before this point). From the point of view of resource efficiency, a WORM file created to comply with a particular data retention regime should only be maintained as such for as long as needed to comply with the retention period specified. Therefore, a retention end date (herein “retention date”) is generally stored as metadata along with the WORM file, the retention date having been determined at the time the WORM file is created on the basis of the retention period (or the longest such period) applicable to data in the file.

Upon expiry of the retention period associated with a WORM file (as judged by comparing the retention date held in the file's metadata with the current time, inclusive of date, provided by a reference time source), the WORM storage system is generally arranged to permit the file's WORM designation to be rescinded. Changes can thereafter be made to the file, subject to normal access permissions. This gives rise to a potential way of illicitly changing file data during its retention period; more particularly, if either the stored retention date can be rolled back to the present or the reference time source rolled forward to the stored retention date, the WORM storage system can be tricked into believing that the retention period for a particular WORM file has expired, and allow the WORM designation of the file to be rescinded and data in the file changed. By restoring WORM designation to the changed file and resetting the stored retention date or reference time source (whichever was changed), the fact that the file data has been altered can be hidden. For this reason, the protection of the nietadata storing the retention date, and the trustworthiness of the current time source, are pertinent considerations in any WORM storage system used for implementing a data retention regime.

### BRIEF DESCRIPTION OF THE DRAWINGS

Embodiments of the invention will now be described, by way of non-limiting example, with reference to the accompanying diagrammatic drawings, in which:

FIG. 1 is a diagram of a server of a clustered storage system implementing an example clock monitoring method and apparatus embodying the present invention;

FIG. 2 is a flow chart of a retention date setting process of a retention management utility of the FIG. 1 embodiment;

FIG. 3 is a flow chart of a retention date expiry-checking process of the retention management utility of the FIG. 1 embodiment;

FIG. 4 is a flow chart of a system clock monitoring process carried out by a clock monitor of the FIG. 1 embodiment;

FIG. 5 is a diagram of an example clustered NAS gateway embodying the present invention; and

FIG. 6 is a diagram of an example clustered filesystem arrangement embodying the present invention.

### DETAILED DESCRIPTION

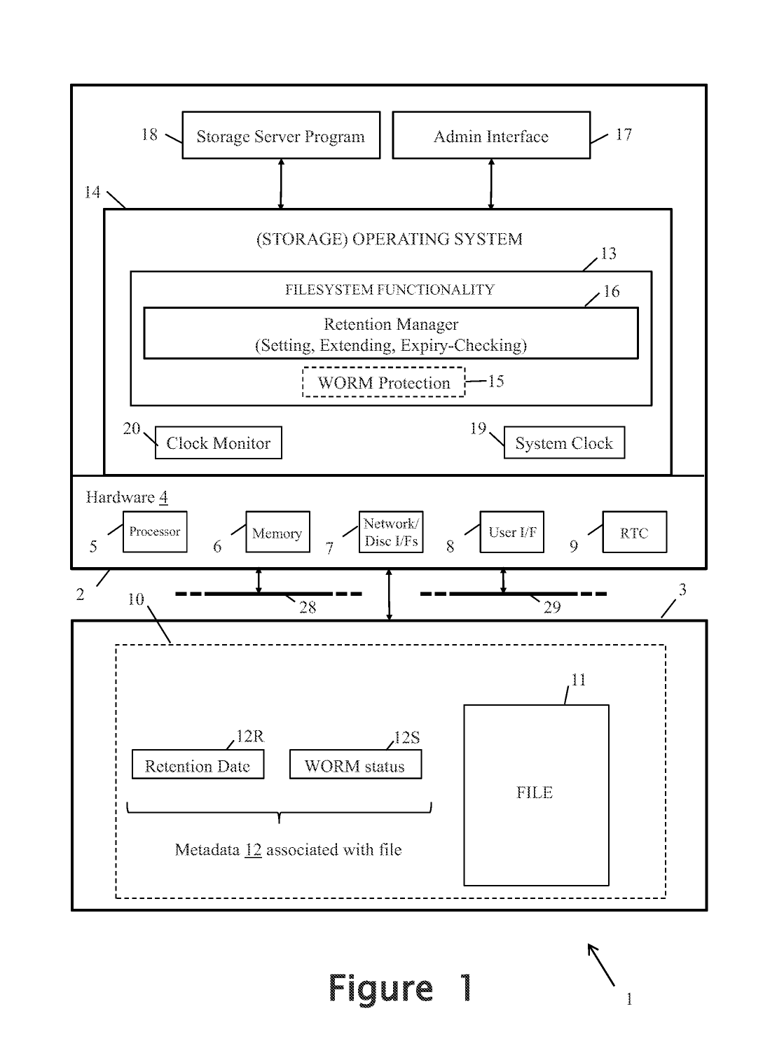

FIG. 1 depicts an example clustered storage system 1 embodying the present invention and comprising multiple server computing machines (servers) 2 only one of which is shown in FIG. 1, and a data storage subsystem 3. The servers 2 are arranged to interface with clients over a data access network 28. The data storage subsystem 3 is provided, for example, by one or more hard disk drives or other storage devices that are either directly attached to the servers and/or connected to the servers over a storage network (not shown). The storage system 1 is arranged to act as a compliance archive for storing files as write-once-read-many, WORM, files during respective retention periods set in accordance with a particular data retention regime. The storage system 1 may also store non WORM files.

The server 2 shown in FIG. 1 comprises standard hardware components 4 arranged to run an operating system 14 and applications 17 and 18. The hardware components 4 include a processor 5 for executing the operating system and application program code, memory 6 (both volatile and non-volatile), network (and, for directly attached storage, disc) interface hardware 7, user interface hardware 8 (such as a monitor, keyboard and mouse), and an always-energized real time clock 9.

The operating system 14 includes filesystem functionality 13 that implements a filesystem 10, that is, an organization of data, held in the storage subsystem 3, and comprising one or more files 11 and associated metadata 12 (represented in FIG. 1 by metadata elements 12P, 12R generally referred to herein as “attributes” of the file). The filesystem functionality 13 can be provided by executable code separate from the operating system 14.

Application 17 is a server program for handling archival requests from clients over the data access network 28 by making appropriate accesses to the storage subsystem 3 to satisfy those requests (subject to certain protection features described below). Application 18 is an administrator interface program.

In the context of a WORM storage system such as the system 1, the filesystem functionality 13 is arranged to provide certain WORM protection features 15 in respect of files that are designated as WORM files, that is, files that are not to be changed but only read. The ‘WORM status’ of a file, that is, whether or not a file is a WORM file, (and therefore whether or not it is subject to protection by the WORM protection features 15) is designated in the file's metadata (attribute 12S in FIG. 1) and may be directly designated using a dedicated WORM-status attribute or implied in the value of a more general attribute. In particular, where a ‘permissions’ attribute is used to record file access permissions (typically ‘read’, ‘write’, ‘execute’ permissions for one or more types of user), then the setting of this attribute to indicate that only read access is permitted for all user types, can equally be taken to indicate that a file is to be treated as a WORM file and that, accordingly, the WORM protection features should be applied. Hereinafter the term “WORM attribute” will be used to mean the attribute being used to indicate the WORM status of a file and is to be understood as encompassing both a dedicated WORM-status attribute and an attribute, such as a ‘permissions’ attribute, from which the WORM status of a file can be inferred.

The WORM protection features 15 provided by the filesystem functionality 13 will, in fact, mostly already be present in connection with enforcing file access permissions (that is, read, write and execute permissions for various types of user). The WORM protection features 15 include the prevention of deletion of, or any change to, a WORM file and at least certain of its attributes, the prevention of deletion of, or any change to, the path or directory structure for locating the file, and the prevention of any recovery, rollback or restoration function that could affect the file or its metadata, path or directory structure. As will be briefly described below, certain limited exceptions to the application of the WORM protection features will generally be appropriate.

The server 2 of the FIG. 1 storage system 5, includes a retention management utility 16 (herein ‘retention manager’) which enables a retention period to be set for each file that is to be treated as a WORM file. The set retention period is stored as file metadata, for example, as attribute 12R in FIG. 1. The WORM protection features 15 are arranged to protect both the WORM attribute 12S and the retention date attribute 12R of a file once the file has been designated a WORM file with the exception that, after the retention date is reached, the WORM status of a file may be changed by changing its WORM attribute (the ability to do this may be restricted to a privileged user). Of course, it would also be possible to arrange for the WORM protection features to allow the WORM attribute of a file to be changed during its retention period, for example, by a privileged user. Exactly what provision is made for changing the WORM status of a file will depend on the regulatory requirements or enterprise policy behind the retention regime being implemented by the storage system. Other exceptions may also be provided to the blanket protection of the WORM attribute and retention-date attribute by the WORM protection features, such as allowing the retention-date attribute to be changed to extend the retention period.

In the present example storage system 5 of FIG. 1, it will be hereinafter assumed, for the purposes of illustration, that the WORM protection features 15 of the filesystem functionality 13 prevent deletion of, or any change to, a WORM file, and at least certain of its attributes including the WORM attribute and retention-date attribute, during the currency of the retention period set for the file except to permit extension of the retention period.

As already noted, in the FIG. 1 storage system, setting a retention period for a file 11 is under the control of the retention manager 16. The retention manager 16 is arranged to receive input regarding the required retention period either from an administrator through interface program 17, or from the storage server application 18 (the latter, for example, being arranged to pass on a specified retention date received from a remote client). The retention manager 16 is operative to convert the retention period into a retention date (that is, the date defining the end of the retention period) and to store this date as file attribute 12R.

As well as initially setting the retention date, the retention manager 16 is also responsible for managing its subsequent extension, for periodically checking for expiry of the retention period set for a file, and for having an administrator, or other party, review a file that has exited its retention period.

In FIG. 1 the retention manager 16 is shown as part of the filesystem functionality 13. However, it is alternatively possible to implement the retention manager 16 as a utility outside of the filesystem functionality 13 and even outside the operating system 14; indeed, the retention manager 16 can be implemented on a different computing machine of the storage system 1 to that hosting the filesystem functionality 13 it is using. In these latter two cases (the retention manager 16 being implemented outside of the operating system 14 or on a different machine), the operating system 14 filesystem functionality 13 will need to authenticate communications from the retention manager 16 (unless a trusted communications path is used) before implementing any changes that effect a retention date or the WORM status of a file.

Checking for expiry of a retention period is done by the retention manager 16 using a clock of the server 2 (in the present example, the system clock 19 provided by the operating system 14). As discussed in the introduction, one way in which a WORM file can be illicitly changed is by rolling forward the clock used for retention-period expiry checking (system clock 19 in the case). In order to detect any interference with the system clock 19, the server 2 is provided with a clock monitoring program (clock monitor 20 of FIG. 1). The clock monitor 20 should be provided on the same machine as the retention manger 16 and can be incorporated into the retention manager 16 or alternatively provided as part of the operating system of the machine hosting the retention manager 16 or even as a separate utility on that machine. In operation, the clock monitor 20 of the server 2 communicates with at least some of the other computing machines of the clustered storage system 1 over a communications infrastructure 29 that is preferably dedicated to communication between the computing machines of the system 1 but may alternatively be shared (for example, with the storage subsystem 3 and/or the data access network 29). This communications infrastructure shared by the computing machines of the storage system 1 may take any form and is referred to below as the “inter-machine network”.

Before describing the clock monitor 20 in detail, a description will first be given of the processes carried out by the retention manager 16 to set and extend a retention date, and to check for retention date expiry.

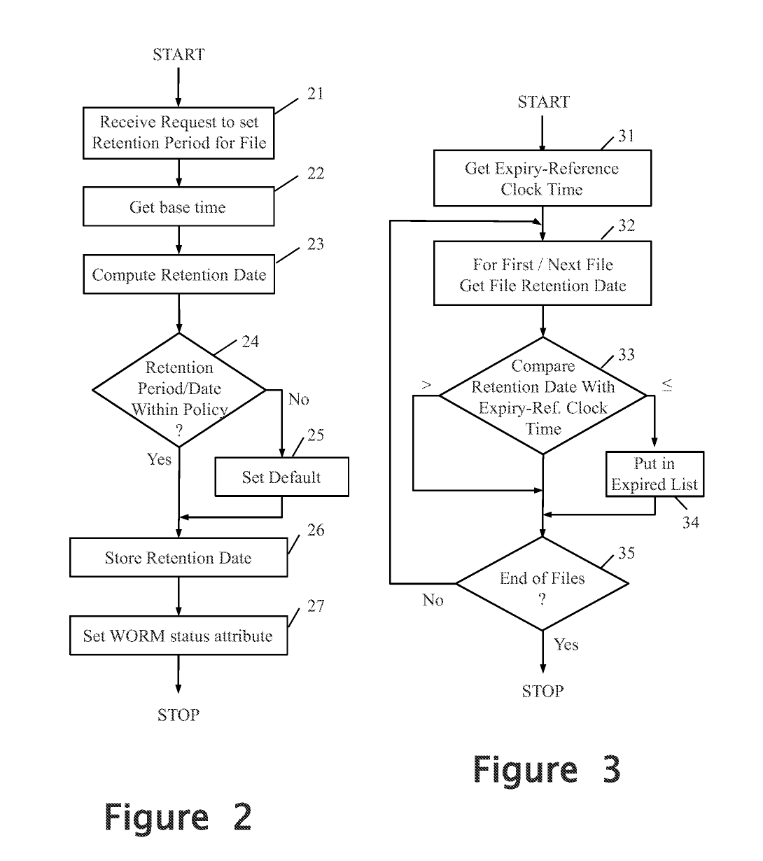

Considering first the process of setting a retention date for a file, a flow chart of this setting process is depicted in FIG. 2 and comprises the following steps:
Step 21 The retention manager 16 receives a request (from the admin interface 17 or server program 18) to set a particular retention period for an identified file (already present in the filesystem).
Step 22 The retention manager 16 retrieves a base time (indicative of the current date); this may be retrieved, for example, from the system clock 19.
Step 23 The retention manager 16 computes the retention date to be stored by adding the particular retention period specified in the request received in step 21 to the base time retrieved in step 22.
Step 24 The retention manager 16 carries out an automatic check as to whether the retention period and/or the retention date complies with the retention policy being implemented. If this check is failed (for example, because the specified retention period is less than a minimum period set by the policy) then step 25 is carried out next; if the check is passed, processing proceeds to step 26.
Step 25 The setting process automatically sets a retention date based on a default retention period and then proceeds to step 26. The default retention period, rather than simply being one fixed period, can be adaptive, being, for example, set to the minimum period allowed in the case of a too-short retention period having been initially specified, and to the maximum allowed in the case of a too-lengthy retention period having been initially specified.
Step 26 The retention manager 16 stores the retention date as an attribute of the file, this attribute may be one dedicated to retention date (and either pre-existing or created in step 26) or an attribute normally used for another purpose but of minor significance while a file is held as a WORM file (such as last access time but not, of course, the WORM attribute).
Step 27 The retention manager 16 designates the file as a WORM file by appropriately setting the WORM attribute.

In a variant of the above-described retention-date setting process, rather than the retention date being calculated as a delta from a base time, a specific retention date may be received as input and used directly (after appropriate checks relative to the retention policy being implemented).

Thus, on completion of the setting process, a retention date has been stored to a file attribute and the WORM attribute set to indicate that the associated file is a WORM file. The WORM protection features 15 subsequently operate to prevent deletion or change of the file, the retention-date attribute, the WORM attribute and, indeed, most of the other attributes of the file concerned.

Handling retention period extension requests is effected by a retention-period extension process (not illustrated) of the retention manager 16, this process operating to validate any extension requests by checking that the new retention date is indeed in advance of that currently stored and, if required by the retention policy, checking that the extension request comes from an appropriately authorised user. Only if these checks are passed is the retention period extended by setting a new retention date in the attribute concerned.

In order to recognize when a WORM file has exited its retention period, the retention manager 16 is arranged to periodically run a retention-period expiry checking process in which it checks for the expiration of the retention period of each file in a predetermined group of files; this group may comprise all WORM files in the filesystem or a subset that, for example, changes at each running of the expiry-checking process such that over a suitably short period of time all the WORM files in the system are checked. A flow chart of the expiry-checking process is depicted in FIG. 3 and comprises the following steps:
Step 31 The retention manager 16 retrieves the current time from the system clock 19; this time, which is to be used as the reference current time for expiry checking, is temporarily held in memory and used throughout the whole process—that is, the same reference current time value is used to check for expiry of all files in the group being checked by the current execution of the expiry-checking process (it will be appreciated that this done for efficiency and it is also possible to read the system clock afresh for each file to be checked).
Step 32 The retention manager 16 accesses the relevant attribute of the first/next file to be checked to retrieve the retention date stored for the file.
Step 33 The retention manager 16 compares the retention date retrieved in step 32 with the current time value retrieved in step 31. If the retention date is equal to, or less than (that is, earlier than) the current time value, step 34 is executed next; otherwise processing continues at step 35.
Step 34 The retention manager 16 adds an identifier of the current file to an ‘expired’ list and processing continues at step 35.
Step 35 Processing in respect of the current file is now complete and the retention manager 16 proceeds by checking whether it has processed all files in the current group; if this is the case, the expiry-checking process terminates, otherwise processing resumes at step 32.

On completion of the retention-date expiry checking process, the retention manager 16 is arranged to initiate a review of the files in the ‘expired’ list by an administrator or other designated party in order to determine the fate of these files.

Rather than carrying out the active retention-date checking process described above, an alternative approach is use lazy discovery of files that have passed their retention dates. With lazy discovery, the retention manager 16 would only check the retention date of a file when that file is touched for some other reason (file read, a delete attempt, filename rename attempt, etc.). A file that has passed its retention date can either be flagged for immediate review or placed in an expired list for review at a later date.

Turning now to a consideration of the clock monitor 20 monitoring for interference with the system clock 19, it is first noted that this clock provides a measure of time elapsed since some standard reference point in time (epoch') typically many years in the past; the time measured by the clock is thus a measure not only of time of day, but also of the passing of calendar days, months and years. The system clock is only operative when the server 2 is running. However, the always-energised hardware real time clock 9 keeps a track of time even when the server 2 is not running. When the server is booted, the system clock 19 is aligned with the current time indicated by the real time clock 9. Both the system clock time and the real clock time are capable of adjustment through software commands (in the case of the real time clock this involves BIOS routines). The present embodiment of the clock monitor 20 is operative to detect any significant adjustments of the system clock 19 (and, indirectly, any significant adjustments the real time clock 9 that are imported into the system clock 19 when the server 2 is booted).

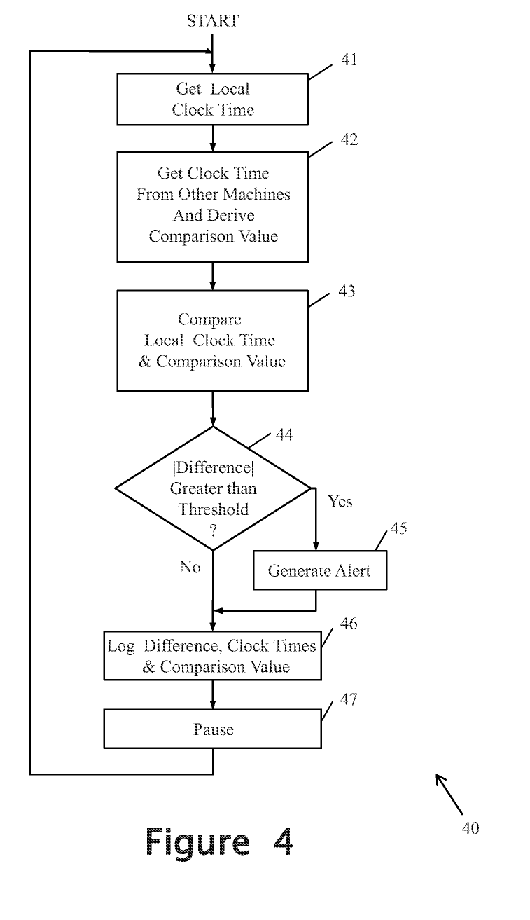

A flow chart of the monitoring process 40 operated by the clock monitor 20 of server 2 is depicted in FIG. 4 and comprises the following steps:
Step 41 The clock monitor 20 gets the current time indicated by the system clock 19 of server 2, (this clock is referred to below as the ‘local’ c;ock of the clock monitor 20 and, more generally, reference herein to the ‘local’ clock of a clock monitor means the clock used for retention-date expiry checking on the same machine as the clock monitor concerned).
Step 42 The clock monitor 20 gets the current times indicating by the system clocks of at least some of the other computing machines of the clustered storage system 1. This is done, for example, by issuing an appropriate system command (such as ‘date’) over the inter-machine network 29, the requested current times being returned over the same network. The returned non-local current clock times, are then used by the clock monitor 20 to derive a value, herein the ‘comparison value’, for comparison with the local current time. The comparison value is derived from the returned non-local current clock times as either a randomly selected one of the returned clock times or as an average value of the returned clock times (or as another statistically determined parameter).
Step 43 The local current clock time obtained in step 41 is then compared with the comparison value derived in step 42 and the magnitude of the difference between them computed.
Step 44 The difference magnitude computed in step 43 is compared with a predetermined threshold amount and if the computed difference magnitude is the greater, step 45 is executed next; otherwise processing continues at step 46. The predetermined threshold amount allows for normal operational variations between the system clock times of different machines (due either to the system clocks themselves or the underlying real time clocks); the predetermined threshold amount is, for example, of the order of five minutes.
Step 45 The existence of a significant difference (i.e. greater than the predetermined threshold amount) between the local current clock time and the comparison value derived from the non-local current clock times, indicates that either the local clock or one or more of the non-local clocks has been interfered with. Accordingly, an alert is generated which may take any appropriate form, for example, a visual output on an operator console of the storage system 1, and/or an electronic message to an administrator of the system, and/or a log entry. Processing continues at step 46.
Step 46 The clock monitor 20 logs at least one of:
   the local and non-local current clock times obtained in steps 41 and 42,
   the comparison value derived in step 42, and
   the difference between the comparison value and the machine's own current time obtained in step 43.
Step 47 The monitoring process 40 is arranged to be repeatedly carried out on an ongoing basis and step 47 times a pause before the next iteration of the process is commenced by returning to step 41. The process 40 is repeated, for example, every hour or daily.

Rather than the current local clock time being obtained as the first step of the monitoring process 40, it can be obtained after receipt back of the non-local current clock times in step 42. Furthermore, in step 45 when an alert is generated, an additional action that can usefully be taken is to prevent files from exiting their retention periods until the clock inconsistencies are resolved. This protects the files during the period of uncertainty.

Running the clock monitoring process 40 on the same machine as the retention manager 16, means that the process 40 is focused on monitoring for interference with the clock used by the retention manager 16 for retention-date expiry checking. The log information provided by the process 40 helps to identify if and when the clock used for expiry checking has been subject to interference. It is, however, possible to obtain a more complete picture by running the same process 40 on the other machines of the storage system 1 from which the clock monitor 20 running on the machine hosting the retention manager 16, has obtained non-local current clock times in step 42. More particularly, to implement this, each of these other machines is arranged to host its own clock monitor 20 to carry out process 40 in respect of its own clock thereby not only to monitor for interference with this clock but also to provide log information useful in understanding interference with clocks in other machines. It will be appreciated that in relation to the execution of the monitoring process 40 on one of these other machines, the terms ‘local’ and ‘non-local’ used above in describing the process 40, are relative to the machine running the process.

It may be noted that although only one server 2 of the clustered storage system 1 is depicted in FIG. 1, the system includes multiple server machines and each may be provided with a retention manager 16 (though this is not necessarily the case as it is possible to provide a single retention manager arranged to service all the servers). Where each server has its own retention manager, it is also provided with its own clock monitor 20 for monitoring the clock used by the retention manager for expiry checking. In this case, the server machines can be arranged to provide each other with the non-local clock times required in step 42 without the need to involve any other machine of the storage system.

Examination of the logs produced by all of the clock monitors 20 each running on a different machine of the storage system allows an administrator of the storage system to identify which system clocks have been interfered with and this, in turn, allows the files that were modified (or at risk of being modified) to be identified. To defeat clock monitoring effected in this way would require the near simultaneous changing of the system clocks of all the machines that run the clock monitoring process 40.

Added security can be provided by spreading the computing machines consulted in step 42 across multiple security domains amongst (i.e. giving them different root passwords), the operational environment being set up such that no single person has sufficient authority to enable them to tamper with time on all the machines consulted.

The above described method and apparatus for monitoring for interference with a clock used in checking for expiry of a file's preset retention date can be applied to any form of clustered storage system. Various forms of clustered storage systems are known and generally differ from one another by the way their servers inter-relate with each other in managing access to the storage subsystem, and whether or not a unified filesystem (single namespace) is implemented. By way of illustration of the applicability of the described clock monitoring method and apparatus to clustered storage systems in general, two examples are given below of how the main elements of the FIG. 1 clustered storage system map onto specific types of clustered storage system.

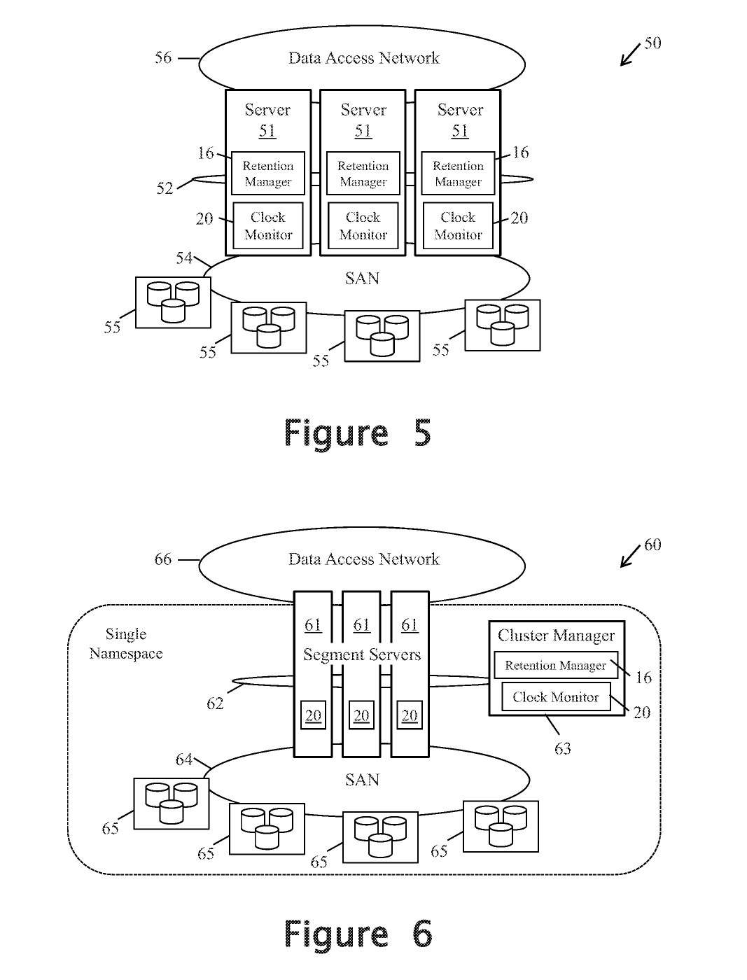

FIG. 5 depicts a clustered NAS (Network Attached Storage) gateway system 50 with three server computing machines 51 each corresponding to the FIG. 1 server 2 and responsible for respective file systems stored in storage units 55 of a storage subsystem accessible via storage area network (SAN) 54. A network 52 (corresponding to the network 29 of FIG. 1) provides for inter-server communication. Clients (not shown) connect to the servers 51 over data access network 56 (corresponding to the network 28 of FIG. 1). Rather than the networks 52, 54, 56 being independent of each other, one or more of these networks may share network infrastructure.

Each of the servers 51 includes a retention manager 16 for effecting retention management in respect of the filesystem(s) for which it is responsible. In carrying out its retention-date expiry checking function, each retention manager 16 is arranged to use the system clock of the server 51 on which it is hosted. Each server 51 also includes a clock monitor 20 arranged to run the clock monitoring process 40 to monitor the server's clock. Each clock monitor 20, in running the process 40, is arranged to obtain clock times in step 42 from all the servers 51 (other than the one on which it is hosted) over network 52.

FIG. 6 depicts a clustered filesystem arrangement 60 in which a single namespace filesystem is distributed across a cluster of server computing machines 61 that all work together to provide high performance service to clients. The clustered filesystem arrangement 60 is, for example, configured to run the Ibrix Fusion duster filesystem software available from Hewlett-Packard Company with components of this software running on each of the servers 61 (termed ‘segment servers’) to provide the unified namespace, and management software running on a duster manager computing machine 63. The segment servers 61 and duster manager 63 are all interconnected with each other by a private network 62 (corresponding to the inter-machine network 29 of FIG. 1). The software component providing the duster manager functionality can alternatively be run on one of the segment server machines. The segment servers 61 connect via a storage area network (SAN) 64 to storage units 65 of a storage subsystem holding the unified filesystem. Clients (not shown) connect to the segment servers 61 over data access network 66 (corresponding to the network 28 of FIG. 1). Rather than the networks 62, 64, 66 being independent of each other, one or more of these networks may share network infrastructure.

In the FIG. 6 storage system 60, the filesystem functionality 13 of FIG. 1, including the WORM protection features 15 but not the retention manager 16, is provided by the filesystem functionality of the individual operating systems of the segments servers 61 (where the operating system used is Linux, the filesystem code is for example, ‘ext2’ or ‘ext-3’). The retention manager 16 of FIG. 1 can conveniently be incorporated into the duster manager 63 of FIG. 6; trusted communication between the retention manager 16 and the filesystem functionality of the individual segment servers 61 takes place over the private network 62. It would alternatively be possible to implement the retention manager 16 by replicating its functionality in each of the segment servers 61.

Clock monitors 20 are provided in each of the segment servers 61 and in the duster manager 63. Each of these clock monitors 20, in running the clock monitoring process 40 to monitor the clock of the machine on which it is hosted, is arranged to obtain non-local clock times (step 42) from each of the other machines 61/63 provided with a clock monitor.

It will be appreciated that many variations are possible to the above described retention-date expiry reference clock monitoring method and apparatus and the clustered storage systems to which they are applied. For example, at least some of the computing machines of the clustered storage systems can be implemented as virtual machines with multiple such machines being hosted on the same underlying computing platforms (this is particularly suitable for the servers 51 of the FIG. 5 clustered NAS gateways as it enables transparent load balancing between the gateway platforms).

In the foregoing, the clock used by the retention manager 16 to check for retention date expiry was the system clock of the machine hosting the retention manager; accordingly this was the clock which the clock monitor 20 was arranged to monitor for interference. However, the retention manager can be arranged to use a different clock of its hosting machine as the expiry reference clock (for example, the real time clock 9). Generally, whatever clock of the hosting machine is used by the retention manager as the expiry reference clock, the clock monitor is arranged to monitor the same clock. With regards to the non-local clocks from which the clock monitor 20 obtains non-local current times in step 42, these do not necessarily need to be the corresponding clocks of the machines concerned but where these other machines also host retention managers and therefore clock monitors of their own, then the clocks used should be the ones serving as expiry reference clocks on the machines concerned.

In the foregoing, the example retention-date expiry reference clock monitoring method and apparatus have been described in relation to clustered storage systems set up for the archival retention of files and their metadata; it is, however, to be understood that the retention-date expiry reference clock monitoring method and apparatus can be used in relation to clustered storage systems set up for archival retention of any structuring of data (herein a ‘dataset’) capable of being handled as a single logical entity and having associated metadata. Furthermore, the purpose for which datasets are stored for retention (for example, archival and/or compliance purposes) is not relevant to the retention-date expiry reference clock monitoring method and apparatus of the present invention which are applicable independently of such purpose. Similarly, although data retention is almost always done under WORM conditions in order to protect the data during its retention period, it will be apparent that whether or not WORM conditions are applied during the retention period does not affect the operation of the retention-date expiry reference clock monitoring method and apparatus of the present invention which are equally applicable whether or not WORM conditions exist during the retention period of particular data.

1. A method of monitoring for interference with a clock used in checking for expiry of a retention period set for a dataset stored in a clustered storage system, the system comprising data storage, and a plurality of computing machines, each with its own clock, including multiple machines configured as servers; a machine of said plurality being arranged to check for dataset retention-period expiry using its own clock as a current time reference; the method comprising the expiry-checking machine repeatedly:
(a) obtaining from at least some of the other computing machines the current times of their clocks, and deriving a comparison value from these times; and
(b) comparing the comparison value it has derived with a current time obtained from its own clock, and generating an alert where they differ by more than a predetermined amount.

2. A method according to claim 1, further comprising the expiry-checking machine, after each of its iteration of (a) and (b), logging at least one of:
the current times obtained in that iteration,
the comparison value derived in that iteration, and
the difference between the comparison value and the machine's own current time obtained in that iteration.

3. A method according to claim 1, further comprising each of said at least some of the other computing machines also repeatedly carrying out (a) and (b) for itself.

4. A method according to claim 3, further comprising each of the computing machines that repeatedly carries out (a) and (b), logging after each of its iteration of (a) and (b) at least one of:
the current times obtained in that iteration,
the comparison value derived in that iteration, and
the difference between the comparison value and the machine's own current time obtained in that iteration.

5. A method according to claim 1, wherein more than one of said plurality of computing machines is arranged to check for dataset retention-period expiry using its own clock as a current time reference, each such expiry-checking machine repeatedly carrying out (a) and (b) for itself.

6. A method according to claim 1, wherein said at least some of the other computing machines from which current clock times are obtained in (a) are spread across multiple security domains.

7. A method according to claim 1, wherein deriving said comparison value from the current times obtained from other computing machines, comprises computing an average of those current times.

8. A method according to claim 1, wherein deriving said comparison value from the current times obtained from other computing machines, comprises randomly selecting one of those current times.

9. A method according to claim 1, wherein the alert comprises at least one of:
a visual output on an operator console;
an electronic message to an administrator; and
a log entry.

10. A method according to claim 1, wherein the said clock of each computing machine is an operating system clock of that machine.

11. A clustered storage system comprising:
a data storage sub-system for storing datasets for retention for respective retention periods,
a plurality of computing machines, each with its own clock, including multiple machines configured as servers; a machine of said plurality being arranged to check for dataset retention-period expiry using its own clock as a current time reference;
the expiry-checking machine including a clock monitor for monitoring for interference with the machine's clock, and the clock monitor being arranged to repeatedly:
(a) obtain from at least some of the other computing machines the current times of their clocks, and derive a comparison value from these times; and
(b) compare the comparison value it has derived with a current time obtained from its own clock, and generate an alert where they differ by more than a predetermined amount.

12. A clustered storage system according to claim 11, wherein the clock monitor, after each of its iteration of (a) and (b), is arranged to log at least one of:
the current times obtained in that iteration,
the comparison value derived in that iteration, and
the difference between the comparison value and the expiry-checking machine's own current time obtained in that iteration.

13. A clustered storage system according to claim 11, wherein each of said at least some of the other computing machines is provided with a respective clock monitor arranged to repeatedly carry out (a) and (b) for that machine.

14. A clustered storage system according to claim 13, wherein each clock monitor, after each of its iteration of (a) and (b), is arranged to log at least one of:
the current times obtained in that iteration,
the comparison value derived in that iteration, and
the difference between the comparison value and the machine's own current time obtained in that iteration.

15. A clustered storage system according to claim 11, wherein more than one of said plurality of computing machines is arranged to check for dataset retention period expiry using its own clock as a current time reference, each such expiry-checking machine including a clock monitor arranged to repeatedly carry out (a) and (h) for that machine.

16. A clustered storage system according to claim 11, wherein the clock monitor is arranged to derive said comparison value from the current times obtained from other computing machines by computing an average of those current times.

17. A clustered storage system according to claim 11, wherein the clock monitor is arranged to derive said comparison value from the current times obtained from other computing machines by randomly selecting one of those current times.

18. A clustered storage system according to claim 11, wherein the clock monitor is arranged to generate said alert as at least one of:
a visual output on an operator console;
an electronic message to an administrator: and
a log entry.

19. A clustered storage system according to claim 11, wherein the said clock of each computing machine is an operating system clock of that machine.

20. A clustered storage system according to claim 11, wherein at least one computing machine is both a said server machine and a said expiry-checking machine.

21. A clustered storage system according to claim 11, wherein the clustered storage system is arranged to provide at least two of said computing machines as virtual machines running on the same computing platform.

22. A clustered storage system according to claim 11, wherein the clustered storage system is arranged to operate as a single name space with different segments thereof being handled by respective ones of the server machines.

23. A clustered storage system according to claim 11, further comprising a communications infrastructure dedicated to communications between said plurality of computing machines, said at least some of the other computing machines being arranged to pass their current times to the expiry-checking machine, over this communications infrastructure.

24. A clustered storage system according to claim 11, wherein during the retention period of a dataset, the clustered storage system is arranged to treat the dataset as a write-once-read-many, WORM, dataset and to protect the dataset from change or deletion.

25. A tangible computer-readable storage medium storing program code for monitoring for interference with a clock used in checking for expiry of a retention period set for a dataset stored in a clustered storage system, the system comprising a plurality of computing machines, each with its own clock, including multiple machines configured as servers; at least one machine of said plurality being arranged to check for dataset retention-period expiry using its own clock as a current time reference; the program code when executed on the expiry-checking machine being operative to cause the latter repeatedly to:
(a) obtain from at least some of the other computing machines the current times of their clocks, and derive a comparison value from these times; and
(b) compare the comparison value it has derived with a current time obtained from its own clock, and generate an alert where they differ by more than a predetermined amount.
